(19) United States
(12) Patent Application Publication
(10) Pub. No.: US 2005/0271759 A1
(43) Pub. Date: Dec. 8, 2005

(54) Apparatus for treating synthetic yarns

(76) Inventor: Rosaldo Fare, Fagnano Olona (VA) (IT)

Correspondence Address: NIXON & VANDERHYE, PC, 901 NORTH GLEBE ROAD, 11TH FLOOR, ARLINGTON, VA, 22203, US

(21) Appl. No.: 11/143,929

(22) Filed: Jun. 3, 2005

(30) Foreign Application Priority Data
Jun. 4, 2004 (IT) MI2004A001137

(51) Int. Cl. B28B 5/00

(52) U.S. Cl. 425/72.2

(57) ABSTRACT

The present invention relates to an apparatus for treating, particularly cooling, synthetic yarns subjected to spinning by means of at least two spinning heads. The apparatus comprises means for blowing a fluid in a substantially crosswise direction relative to the yarns at the outlet from said spinning heads, and furthermore it advantageously comprises one or more devices for moving the air being present between said means and the spinning heads. The fluid is particularly a cooling fluid.

The present invention relates to an apparatus for treating synthetic yarns upon the manufacturing step.

In the field of manufacturing synthetic yarns, it is known to use apparatuses having the function of cooling the yarns at the outlet from the spinning heads. In fact, in the manufacture of synthetic yarns polymers are normally extruded at high temperatures through one or more spinnerets mounted on suitable spinning heads, and cooling is carried out in order to minimize the risk that the yarns may be damaged, while increasing the productivity of the process. The spinning heads may comprise one or more spinnerets. The number, arrangement and shape of the spinnerets depend on the type of processing and the type of yarns to be treated. The spinnerets can, in turn, have a distribution of holes for polymers of a rectangular, circular type, etc., to be passed therethrough, and can be arranged in various manners on a spinning head.

Traditionally, synthetic yarns can be obtained by processing different types of polymers such as polyamide, polypropylene, polyethylene, polyester, polyethylene terephthalate, etc. Upon processing, the temperature of these polymers can range between some tens of centigrade degrees and several hundreds of centigrade degrees, according to the particular polymer being processed and the type of spinning, and for this reason, the yarns at the outlet from the spinnerets are likely to stick to each other, with clear negative consequences for the product quality and productivity of the spinning process.

Typically, yarn cooling is obtained by means of apparatuses that are positioned beside the yarns at the outlet from a spinning head. With the commercially available apparatuses, yarn cooling is usually provided by means of one or more air flows that are directed crosswise to the yarns relative to their outlet direction from the spinnerets. In practice, a traditional apparatus is able to supply the air only from one side of a spinning head. In order to improve yarn cooling, a technical solution has been established since some time, which provides using two apparatuses that are positioned opposite each other, each being on a side of a spinning head, such that the air is supplied to the yarns from the two opposite sides of the spinning head. With this solution, one can obtain a more effective yarn cooling compared with the cooling that can be obtained with an individual apparatus, but at the same time, this solution requires a larger area in the spinning plant to be destined to the second apparatus.

In the manufacture of synthetic yarns, a plurality of spinning heads positioned in-line, i.e. beside each other, is often provided. In this case, in addition to yarn cooling, other problems arise from the large volumes occupied by the cooling apparatuses, which require a suitable space to be arranged in the close vicinity of the spinning heads. In particular, since one or two traditional apparatuses are required for each spinning head, the in-line spinning heads are to be spaced apart for said apparatuses to be positioned, with clear negative consequences for the extension of the spinning plant and the management of the same.

Furthermore, traditional apparatuses are subjected to air heating in the area comprised between each apparatus and the spinning head/s associated thereto. This heating, which is due to the heat released in the air by the spinnerets, yarns and members of the apparatuses, often results in a local thermal storage that negatively affects the spinning process. In fact, the air temperature increase in the vicinity of a cooling apparatus and of the spinning heads reduces the effectiveness of the cooling carried out by the apparatus itself on the yarns.

The object of the present invention is to provide an apparatus for cooling synthetic yarns at the outlet from spinning heads that overcomes the problems of the traditional apparatuses in an easy and cost-effective manner, while enabling to increase the productivity of the spinning process and the quality of the yarns processed.

It is also an object of the present invention to provide an apparatus for cooling synthetic yarns enabling to cool the yarns at the outlet from two or more adjacent spinning heads.

A further object of the present invention is to provide an apparatus for cooling synthetic yarns at the outlet from spinning heads, enabling to minimize, if not suppress, the thermal storage generated between the apparatus and the spinning heads being close thereto.

These and other objects are achieved by the present invention, which relates to an apparatus for treating synthetic yarns being subjected to spinning by means of at least two in-line spinning heads, comprising means for blowing a fluid in one or more directions such as to intercept said yarns at the outlet from said spinning heads, said means also being provided in an intermediate position relative to said spinning heads and being provided with devices suitable to move the air in said intermediate positions.

Advantageously, the apparatus according to the invention, that is particularly suitable to cool the synthetic yarns at the outlet from the spinning heads, provides one or more devices for moving the air that is mainly localized between the means for blowing the fluid and the spinning heads. Thereby, thermal storage between the apparatus and the adjacent spinning heads can be minimized, if not suppressed. Moving the air in this area can be obtained by sucking the air and/or blowing the fluid. To this purpose, traditional equipment can be used, such as blowers, fans, suction fans, etc. According to an embodiment of the invention, air suction is obtained by means of one or more venturi tubes being associated with the means for blowing the fluid. Furthermore, the apparatus can be provided with air-cooling surfaces in said area, which are either associated with a hydraulic circuit that is based, for example, on the circulation of a cooling liquid, or associated with thermo-electrical means, such as Peltier cells.

Preferably, the fluid is a cooling fluid, more preferably the fluid supplied to the yarns is air. However, other fluids can be used with the apparatus according to the invention such as gas, carbon dioxide, inert gases, etc., and/or mixtures thereof.

With the apparatus according to the present invention, a cooling fluid can be supplied to the yarns at the outlet from at least two adjacent spinning heads. Compared with the traditional solutions, a great simplification in the layout of the spinning heads in the plants can be obtained with the apparatus. according to the invention. This feature is particularly advantageous when the spinning heads are arranged in-line, since the space between adjacent spinning heads in the line can be minimized, while maintaining a good cooling effect and accordingly high production volumes.

Furthermore, the apparatus according to the invention enables to minimize, if not suppress, the storage of heat in the air in an area comprised between the apparatus and the spinning heads being associated therewith, with clear advantages for the productivity of the plant.

Particularly, the invention enables to treat a greater amount of yarns per unit time, for example in terms of number of the filaments composing the yarns, per linear meter, compared with the amount being obtained with the traditional apparatuses that can be associated with the spinning heads.

The inventive apparatus can be applied to the traditional spinning processes, either continuous or in batch, as well as the “long” or “short” spinning processes and those spinning processes providing spun bonding for non-wovens or traditional yarns.

By using the apparatus according to the invention in association with the traditional spinning heads, synthetic yarns can be obtained with a final count ranging between 0.5 dtex and 50 dtex for the individual filaments.

Further aspects and the advantages of the present invention will be better understood from the description below, which is to be considered by way of a non-limiting example with reference to the annexed figures, in which:

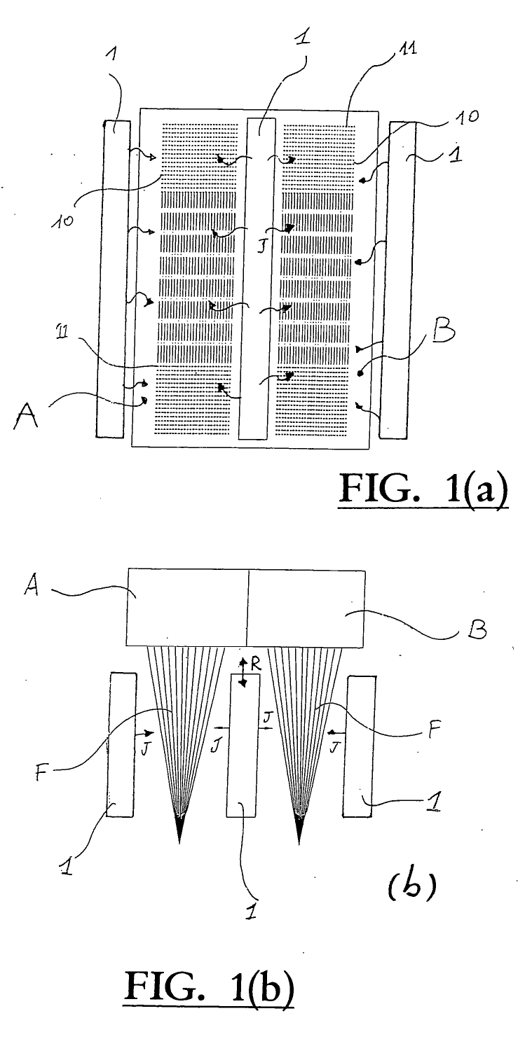

FIG. 1 comprises two schematic views of a set of apparatuses according to the invention being associated with two spinning heads;

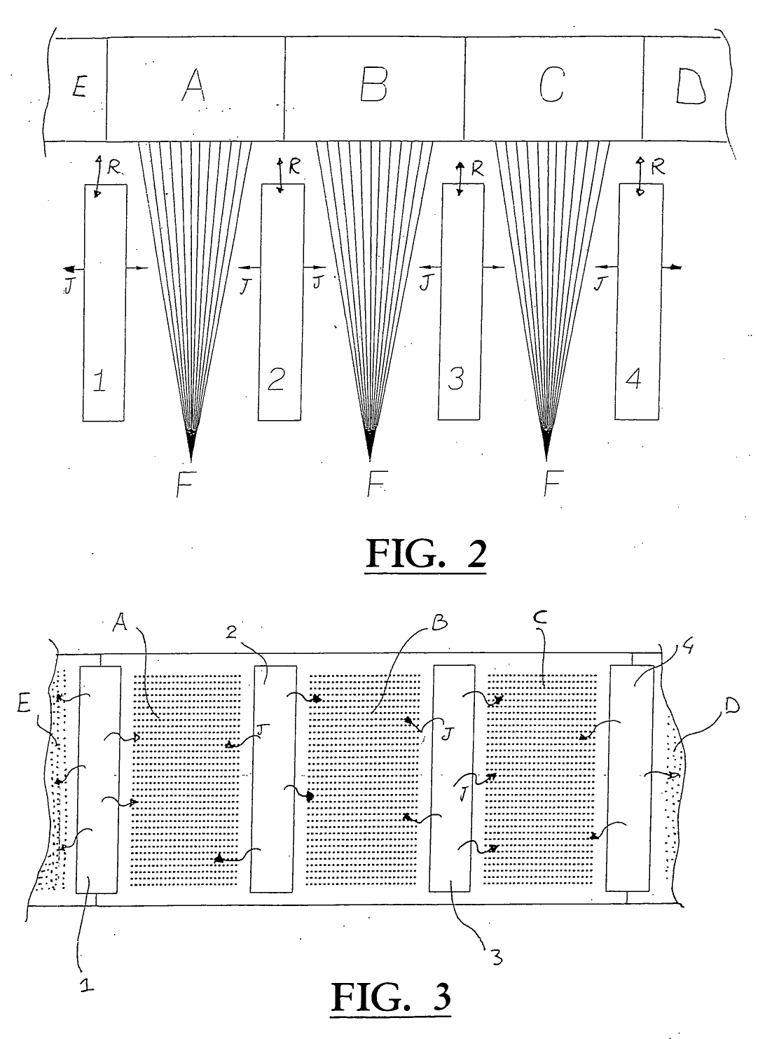

FIG. 2 is a schematic view of a spinning plant being provided with several apparatuses according to the present invention and several in-line spinning heads.

FIG. 3 is a front view of the plant of FIG. 2;

FIG. 1 comprises two schematic views of an apparatus according to the invention for cooling yarns being processed by one or more spinning heads. Particularly, FIG. 1b is a plan layout showing an apparatus 1 according to the invention being positioned between two spinning heads A and B, as well as outside each of them, which spinning heads are used for treating synthetic fibers F. FIG. 1a is a front schematic view of the apparatus 1 and spinning heads A and B.

The spinning heads A and B can be of a different type, according to the type of spinning to be carried out, the type of fibers to be treated and the amount of the same. In the case illustrated, the heads A and B are provided with spinnerets 10, the holes 11 thereof being distributed in a substantially rectangular manner. The apparatus 1 can be generally associated with spinning heads provided with one or more spinnerets having holes distributed in a circular, circle crown type manner, etc.

The apparatus 1 can have different shapes and/or components according to the space requirements and manufacture requirements of the spinning plant being associated therewith. In order to cool the yarns F at the outlet from the spinning head A, the apparatus 1 supplies a flow J of cooling fluid to the yarns F, preferably in the crosswise direction relative to the outlet direction of the yarns F from the spinning head A. The flow J can be either individual, or formed by a plurality of jets of cooling fluid, each being supplied by means that are equivalent to each other, such as fans, blowers, nozzles, etc., and directed such as to intercept the yarns at the outlet from different portions of the head A. The speed and flow rate of the flow J can be adjusted through these means.

The fluid, which is preferably a cooling fluid, can be air, gas, or a mixture thereof and can be cooled through suitable means, before being supplied to the yarns F. Due to cost reasons, in the preferred embodiment of the apparatus 1 the cooling fluid is air, for example the air of the room where the apparatus 1 is positioned, or external air.

Advantageously, and contrary to known apparatuses, the apparatus 1 can supply a second flow J of cooling fluid to the yarns at the outlet from a second spinning head B, such as illustrated in FIG. 1, since it is positioned in the middle between the two spinning heads and accompanied by two other apparatuses positioned on the sides of each spinning head A and B at the outlet of the yarns. By this feature, a great simplification of the spinning plants can be obtained. In fact, according to the invention, the yarns processed by two in-line spinning heads A and B, i.e. adjacent in a spinning plant, can be effectively cooled, without overheating the area therebetween, contrary to what occurs with known apparatuses, each of which can be operatively associated with an individual spinning head A or B. Thus, with the apparatus 1 the spinning heads can be positioned adjacent to each other, with clear advantages for the plant layout.

With reference, for example, to FIGS. 2 and 3, a possible use of several apparatuses 1, 2, 3 and 4 according to the present invention for cooling yarns F processed by a series of spinning heads A, B, C, D and E is illustrated. Each apparatus 1, 2, 3 or 4 supplies two flows J to the yarns at the outlet from two spinning heads. Thereby, the yarns F at the outlet from a spinning head, such as the head B, are cooled on both sides, through two flows J supplied from the apparatuses 2 and 3. By means of the two counter-posed flows J, the turbulence of the air between the yarns F is increased, and the heat exchange between the individual filaments composing the yarns and the surrounding air is consequently improved. In practice, by increasing the turbulence of the air between the filaments, the release of heat in the air by the filaments is improved, thereby the cooling process of the yarns F is improved as a whole. By using an apparatus 1 according to the invention, not only the risk of damage, sticking, etc. of the yarns can be minimized, but high-quality yarns can be also obtained. For example, synthetic yarns with a final count ranging between 0.5 dtex and 50 dtex per individual filament can be obtained by means of the apparatus 1 associated with traditional spinning heads.

The apparatus 1, 2, 3 or 4 of the invention can be applied to traditional spinning processes, either continuous or in batch, as well as non-woven spinning processes.

Furthermore, the apparatus 1, 2, 3 or 4 according to the invention is preferably provided with means for moving the air mainly located in the gap or area comprised between the apparatus and the spinning head/s A and/or B and/or C, etc. being associated therewith. With reference to the FIG. 1b and 2, the area comprised between the apparatus 1 and the spinning heads A and B is designated with R. The air in the vicinity of the area R is usually subjected to overheating, which reduces the efficacy of yarn cooling. The means for moving the air in the area R can suck and/or blow the same. For example, the apparatus 1, 2, 3, 4 can be provided with fans, suction fans or other equivalent devices that are positioned such as to intercept the air stagnating in this area R. According to an embodiment of the present invention, the apparatus can be provided with devices for cooling the air that may be drawn from the area R and ricirculated in the same area R. These devices may comprise cooling circuits, thermoelectric circuits, etc.

The apparatus 1, as well as 2, 3, 4 in FIG. 2, enables to greatly reduce the overheating of the air in the area R, and accordingly the overheating of the spinnerets of the spinning heads A and B, as well as C and D, with clear positive consequences for the efficacy in the cooling of the yarns F and the quality of the yarns F being processed.

In order to avoid that dangerous electrostatic discharges may form at the surfaces thereof, the apparatus according to the invention may be provided with suitable devices for grounding these discharges.

The apparatus according to the invention can be used for cooling synthetic yarns F being obtained from different types of polymers, such as polyamides, polyolefins, polyethylenes, polyester, polyethylene terephthalate, etc.

1. An apparatus for treating synthetic yarns subjected to spinning by means of at least two in-line spinning heads, comprising means for blowing a fluid in one or more directions such as to intercept said yarns at the outlet from said spinning heads, said means also being provided in an intermediate position relative to said spinning heads and being provided with devices suitable to move the air in said intermediate positions.

2. The apparatus according to claim 1, characterized in that said air is mainly located between said means and said spinning heads.

3. The apparatus according to claim 2, characterized in that said moving of the air is obtained by sucking the air and/or blowing said fluid.

4. The apparatus according to claim 3, characterized in that air suction is obtained by means of one or more venturi tubes being associated with said means.

5. The apparatus according to claim 1, characterized in that said fluid is a cooling fluid.

6. The apparatus according to claim 5, characterized in that said cooling fluid is air.

7. Use of an apparatus according to claim 1 for spinning synthetic yarns through a series of adjacent spinning heads.

8. A plant for spinning synthetic yarns through a series of spinning heads, which is provided with one or more apparatuses according to claim 1, each apparatus being also provided in the intermediate position between two adjacent spinning heads.
